(19) United States
(12) Patent Application Publication
(10) Pub. No.: US 2024/0146986 A1
(43) Pub. Date: May 2, 2024

(54) AUTOMATIC DEFERRED EDGE AUTHENTICATION FOR PROTECTED MULTI-TENANT RESOURCE MANAGEMENT SYSTEMS

(71) Applicant: Adobe Inc., San Jose, CA (US)

(72) Inventors: Tobias Bocanegra Alvarez, Zurich (CH); David Nuescheler, Salt Lake City, UT (US)

(21) Appl. No.: 18/051,424

(22) Filed: Oct. 31, 2022

(51) Int. Cl. H04N 21/258; H04N 21/442; H04N 21/835

(52) U.S. Cl. CPC H04N 21/25816; H04N 21/44204; H04N 21/835

(57) ABSTRACT

The present disclosure relates to systems, non-transitory computer-readable media, and methods for utilizing deferred edge authentication to validate requests for resources of a content delivery network. In one or more embodiments, the disclosed systems receive, at an edge server from a client device, a request for a content item. In some embodiments, in response to receiving the request, the disclosed systems determine that the content item is stored at the edge server with a corresponding response header received from an origin server and validate the request, at the edge server, utilizing security information from the response header. In some embodiments, in response to receiving the request, the disclosed systems determine that the content item is not available at the edge server, request the content item from the origin server, and receive the content item with the corresponding response header from the origin server.

### BACKGROUND

In recent years, conventional multi-tenant networks and systems have frequently implemented content delivery networks (CDNs) to manage and deliver digital resources to tenants and/or users. For instance, online or network resources can be cached close to an end user within one or more edge servers of a content deliver network to enable faster delivery of such resources. For resources that are protected by access control, conventional systems depend on a cached key that represents the access control state of the resource and includes security information, such as lists of protected resources, authorized parties, and authentication parameters. Also, when using a single edge service to serve multi-tenant systems, the aforementioned security information is often configured for each individual tenant or user group.

Conventional content delivery networks often store such information in security dictionaries at the edge servers. However, the operational overhead of maintaining security dictionaries at edge servers is significant and presents additional difficulties when scaling the system for a greater number of tenants. For example, cached dictionaries at edge servers require updates from origin servers to ensure accurate security information for each tenant is synchronized across the entire system, which can lead to deficiencies in system accuracy, efficiency, flexibility, and security.

These along with additional problems and issues exist with regard to resource management systems utilizing content delivery networks to provide protected resources under access control.

### BRIEF SUMMARY

Embodiments of the present disclosure solve one or more of the foregoing or other problems in the art with systems, non-transitory computer-readable media, and methods for providing deferred edge authentication of requests to access protected resources on a multi-tenant system. For example, the disclosed systems and methods store access control information in response headers attached to cached resources to improve efficiency, ensure accuracy, and increase the flexibility of content delivery networks in providing access to protected resources in a multi-tenant environment.

To illustrate, in some embodiments, the disclosed systems receive from a client device, at one or more edge servers of a content delivery network, a request to access a protected resource or content item. In some implementations, the disclosed systems determine, in response to receiving the request, that the protected content item is cached (i.e., stored) at the one or more edge servers with a corresponding response header received from an origin server of the content delivery network. In response, the disclosed systems validate, utilizing security information from the response header at the one or more edge servers, the request for access to the protected resource or content item. Upon validation of the request, in some implementations, the disclosed systems deliver the protected resource or content item from the one or more edge servers to the client device.

Accordingly, by including security information in response headers attached to cached resources, the disclosed systems improve the accuracy of security information and the efficiency of maintaining security information cached at edge servers of content delivery networks. Moreover, the disclosed systems improve the flexibility of content delivery networks in providing access control to protected documents in multi-tenant environments.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a deferred authentication system operates in accordance with one or more embodiments.

FIG. 2 illustrates an overview of a content delivery network utilizing a deferred authentication system in accordance with one or more embodiments.

FIG. 3 illustrates a deferred authentication system utilizing an origin server of a content delivery network to provide security information to an edge server in accordance with one or more embodiments.

FIGS. 4A-4B illustrate two process flowcharts of a deferred authentication system providing a content item in response to a request from a client device in accordance with one or more embodiments.

FIG. 5 illustrates a schematic diagram of a deferred authentication system in accordance with one or more embodiments.

FIG. 6 illustrates a flowchart of a series of acts for validating a request to access a protected content item utilizing a deferred authentication system in accordance with one or more embodiments.

FIG. 7 illustrates a block diagram of an example computing device in accordance with one or more embodiments.

### DETAILED DESCRIPTION

This disclosure describes one or more embodiments of a deferred authentication system that utilizes edge servers of a content delivery network to provide deferred authentication of requests for access to protected resources. For example, the deferred authentication system utilizes access control information attached to resources cached at an edge server to perform deferred authentication. Upon initial caching of each resource at the edge server, for example, access control information is provided by an origin server of the content delivery network and attached to each resource for subsequent use in deferred authentication, thus foregoing the need for an exhaustive edge-based access control dictionary.

To further illustrate, in one or more embodiments, the deferred authentication system receives from a client device, at one or more edge servers of a content delivery network, a request to access a protected resource or content item. In response to receiving the request, the deferred authentication system determines, in some implementations, that the protected resource or content item is cached (i.e., stored) at the one or more edge servers with a corresponding response header received from an origin server of the content delivery network. In response to determining that the protected resource is cached with the respective response header, the deferred authentication system validates, utilizing security information from the response header at the one or more edge servers, the request for access to the protected resource or content item. Upon validation of the request, in some implementations, the deferred authentication system delivers the protected resource or content item from the one or more edge servers to the client device.

In some implementations, the deferred authentication system determines, in response to receiving a request for access to a protected resource or content item, that the protected resource or content item is not cached (i.e., stored) at the one or more edge servers. In response, in one or more embodiments, the deferred authentication system generates a request, to the origin server, for the protected resource or content item and receives, from the origin server, the protected resource or content item with a response header comprising security information from a security information repository of the origin server. Utilizing the security information from the response header, the deferred authentication system validates the request to access the protected resource or content item and, in some implementations, delivers the protected resource or content item from the one or more edge servers to the client device. In some embodiments, the deferred authentication system validates additional requests for the protected resource or content item received from the origin server utilizing the security information from the response header.

In one or more implementations, the disclosed deferred authentication system provides a variety of advantages and benefits over conventional systems and methods. For example, by attaching access control information to individual resources delivered by origin servers to edge servers, in one or more implementations the deferred authentication system improves the accuracy, efficiency, and flexibility of access control processes relative to conventional systems (e.g., relative to systems that store access control information in edge-based dictionaries or require authentication at origin servers).

For instance, the disclosed deferred authentication system significantly improves the accuracy of security information cached at edge servers of a content delivery network by reducing the operation overhead of updating such information. In many conventional multi-tenant systems, for example, edge dictionaries include an exhaustive catalog of authentication parameters configured for each tenant and for each resource available. Such edge dictionaries can require extensive operation overhead as parameters for tenants, groups of tenants, and resources need to be updated periodically with information from a back-end repository (e.g., information stored at one or more origin servers), which in turn increased the risk of errors and/or security breaches due to inaccurate or outdated security information.

In addition to improved accuracy of information, in some implementations the deferred authentication system also exhibits increased efficiency relative to conventional systems. Indeed, relative to searching for authentication parameters in an extensive dictionary cached at the edge or and/or origin servers, the deferred authentication system improves speed and reduces computational and operational overhead by attaching information to resources as they are cached at the edge server(s).

Also, by attaching access control information to individual resources, in one or more embodiments the deferred authentication system increases the flexibility of content delivery networks to be expanded to include additional tenants, resources, and access control measures. Indeed, in one or more embodiments, the deferred authentication system can reliably implement system-wide changes by incrementally updating cached security information as individual resources are requested from edge servers. Further, when additional resources are made available at the back end, the deferred authentication system does not need to update edge dictionaries, as the security information corresponding to the additional resources are provided as each resource is individually delivered from origin servers to be cached in edge servers.

As illustrated by the foregoing discussion, the present disclosure utilizes a variety of terms to describe features and advantages of the deferred authentication system. Additional detail is now provided regarding the meaning of such terms. For example, as used herein, the term “content delivery network” refers to a network of servers that distributes content from one or more origin servers to multiple locations by caching content close to where each end user is accessing the network via a client device. For instance, the content requested by end users is first stored on the one or more origin servers and is subsequently delivered and stored on one or more edge servers located in closer proximity to the end user.

Relatedly, as used herein, the term “origin server” (sometimes referred to as “back-end server”) refers to one or more computers configured to store content and run programs for processing incoming network requests. In some cases, the origin server includes a security information repository wherein access control data is stored and maintained as a source of truth for the network. For example, a security information repository includes authentication and authorization information corresponding to tenants of the network or system and individual resources (i.e., content) available via the origin server.

Moreover, as used herein, the term “edge server” refers to a server (i.e., computer) that provides end users with cached versions of static content from origin servers. For example, an edge server is typically closer in proximity to one or more end users than the location of the origin servers of the same network. Accordingly, edge servers are configured to provide cached content, originally provided to the edge servers by one or more origin servers, to end users with increased speed and efficiency relative to providing the service via the origin servers.

Also, as used herein, the terms “multi-tenant network” and “multi-tenant system” refer to an architecture in which individual resources are provided to multiple tenants of the network or system. For example, a tenant of a multi-tenant network or system can include a user or a group of users who share a common access with specific privileges to one or more resources of the network or system. Also, a multi-tenant network or system can include a cloud storage system or other content management systems wherein multiple tenants have access to one or more resources or content items.

In addition, as used herein, the term “resource” (or “content item”) refers to data or other items accessible via a computer network. For example, a resource or content item includes documents, videos, photos, webpages, access to remote software applications, and so forth. In some cases, a resource or content item is referred to herein as a “protected” resource or content item to indicate that the protected resource or content item is subject to access control.

Relatedly, as used herein, the term “response header” refers to a component of a network packet that is sent by a server to another server or client device in response to a network request. For example, a response header can include one or more HyperText Transfer Protocol (HTTP) response headers attached to a requested resource or content item and containing various information pertaining to the resource of content item. For example, a response header can include a collection of multiple HTTP response headers that collectively reflect authentication information, where each HTTP response header includes a name and a value (e.g., a name-value pair). Moreover, embodiments can implement alternative response headers not limited to HTTP standards, such as alternative forms of metadata.

Additionally, as used herein, the term “access control” refers to a security model that regulates access to resources in a computing environment. For example, access control can include authentication of various login credentials (e.g., usernames, passwords, pins, scans, or security tokens) and granting authorization depending on whether the authenticated user and/or application is indicated as approved for access to a particular resource or content item. As used herein, the term “authentication” refers to a process for verifying the identity of a user, a process, or an application. Also, as used herein, the term “authorization” refers to a process for identifying users, user groups, processes, or applications as having permission or authority to access a particular resource or content item. Additionally, as used herein, the term “validation” refers to a process including authentication and authorization procedures in response to a request for access to a protected resource or content item.

Relatedly, as used herein, the term “token” or “authentication token” refers to a software component or hardware device for providing the information required to authenticate a user, application, and/or device. For example, a token can include a JSON web token, or JWT, comprising one or more of a header, payload, or signature in accordance with the JSON web encryption and/or signature standards. Moreover, embodiments of the present disclosure can include authentication tokens according to any standard operable to provide secure authentication, including but not limited to tokens provided and/or verified by a native or third-party identity provider (IDP) service.

In addition, as used herein, the term “public key” or “authentication key” refers to cryptographic key for encrypting and/or decrypting information, such as that contained in an authentication token. For example, an authentication key can include a numeric or alphanumeric value generated by a software program at an origin server or by a designated third-party IDP.

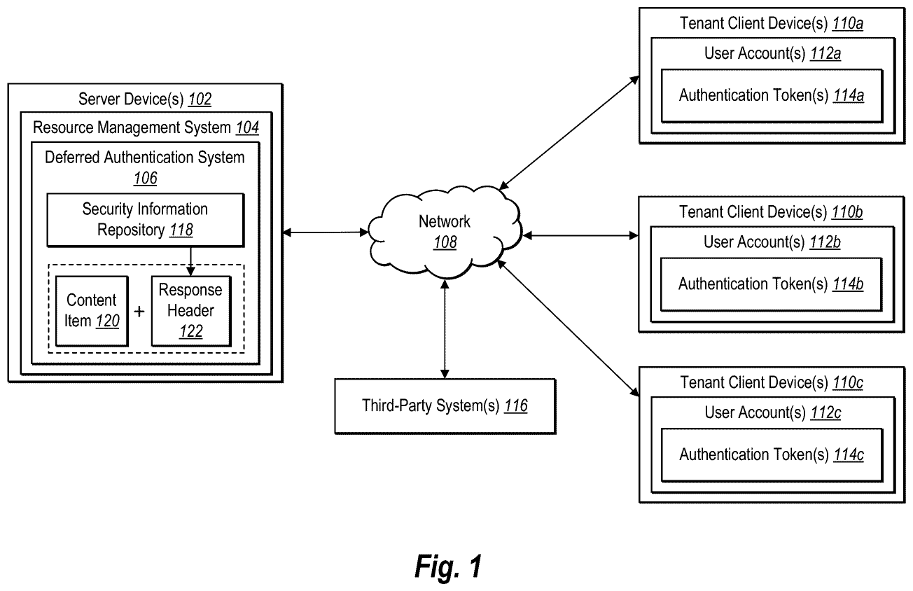

Turning now to the figures, FIG. 1 illustrates a schematic diagram of one embodiment of a multi-tenant system (or environment) in which a deferred authentication system 106 operates in accordance with one or more embodiments. As illustrated, the system includes server device(s) 102, a network 108, multiple tenant client device(s) 110a-c, and third-party system(s) 116. As further illustrated, the server device(s) 102, the tenant client device(s) 110a-c, and the third-party system(s) 116 communicate with one another via the network 108. As illustrated, each tenant of the multi-tenant system may be associated with multiple client devices. Also, while FIG. 1 shows three sets of tenant client device(s) 110a-c, one or more embodiments include additional tenants (or fewer tenants) associated with the multi-tenant system.

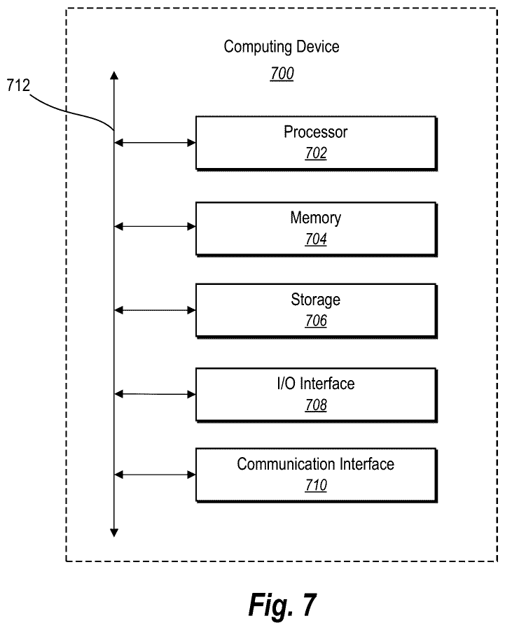

As shown in FIG. 1, the server device(s) 102 include a resource management system 104 that further includes the deferred authentication system 106. For instance, the server device(s) 102 includes, but is not limited to, a computing device (such as explained below in reference to FIG. 7). In some embodiments, the deferred authentication system 106 generates a response header 122 for a content item 120, the response header 122 comprising security information for the content item 120 provided by a security information repository 118. Additionally or alternatively, the deferred authentication system 106 utilizes security information (e.g., encryption information/keys) provided by the third-party system(s) 116, such as but not limited to an identity provider (IDP) service.

Furthermore, as shown in FIG. 1, the illustrated system includes the tenant client devices 110a-c. In some embodiments, the tenant client devices 110a-c include, but are not limited to, mobile devices (e.g., smartphones, tablets), laptop computers, desktop computers, or any other type of computing devices, including those explained below in reference to FIG. 7. Although not shown in FIG. 1, some embodiments of tenant client devices 110a-c are operated by a user to perform a variety of functions via respective user accounts 112a-c. For example, the tenant client devices 110a-c (via the user account(s) 112a-c) perform functions such as, but not limited to, requesting access to resources (e.g., content item 120) through network 108. In addition, in some embodiments, the tenant client devices 110a-c provide one or more authentication tokens 114a-c for identity verification (i.e., authentication) to the deferred authentication system 106 when requesting access to resources. In one or more embodiments, the authentication tokens 114a-c are provided by the third-party system(s) 116, such as but not limited to an identity provider (IDP) service.

To access the functionalities of the resource management system 104 (e.g., to access resources, such as content item 120), in one or more embodiments, a user interacts with the server device(s) 102 via the user's tenant client device 110a-c. For example, the tenant client device(s) include one or more software applications (e.g., to interact with the server device(s) 102) installed on the tenant client device(s) 110a-c. In certain instances, the one or more software applications are hosted on the server device(s) 102. Additionally, when hosted on the server device(s) 102, the one or more software applications are accessed by the tenant client devices 110a-c through a web browser and/or another online interfacing platform and/or tool.

Although FIG. 1 illustrates the deferred authentication system 106 being implemented by a particular component and/or device within the illustrated system (e.g., the server device(s) 102), in some embodiments the deferred authentication system 106 is implemented, in whole or part, by other computing devices and/or components. For instance, in some embodiments, the deferred authentication system 106 is implemented by one or more servers of a content delivery network, and/or by one or more third-party systems 116, such as an identity provider (IDP) service or other information security provider.

As further shown in FIG. 1, the illustrated system includes the security information repository 118. In one or more embodiments, the security information repository 118 includes, but is not limited to, a server device, a cloud service computing device, or any other type of computing device (including those explained below with reference to FIG. 7) that stores security information associated with resources and tenants of the resource management system 104. In some embodiments, the deferred authentication system 106 accesses the security information repository 118 to retrieve security information associated with a particular resource, such as the content item 120. While FIG. 1 shows the security information repository 118 within the server device(s) 102, in some embodiments the security information repository 118 is accessibly located elsewhere within the system(or environment), such an alternative server or within the third-party system(s) 116.

Additionally, as shown in FIG. 1, the illustrated system includes the network 108. As mentioned above, in some instances, the network 108 enables communication between components of the system. In certain embodiments, the network 108 includes a suitable network and may communicate using any communication platforms and technologies suitable for transporting data and/or communication signals, examples of which are described with reference to FIG. 7. Furthermore, although FIG. 1 illustrates the server device(s) 102, the tenant client devices 110a-c, and the third-party system(s) 116 communicating via the network 108, in certain embodiments, the various components of the system communicate and/or interact via other methods (e.g., the server device(s) 102 and the client device 110a-c communicating directly).

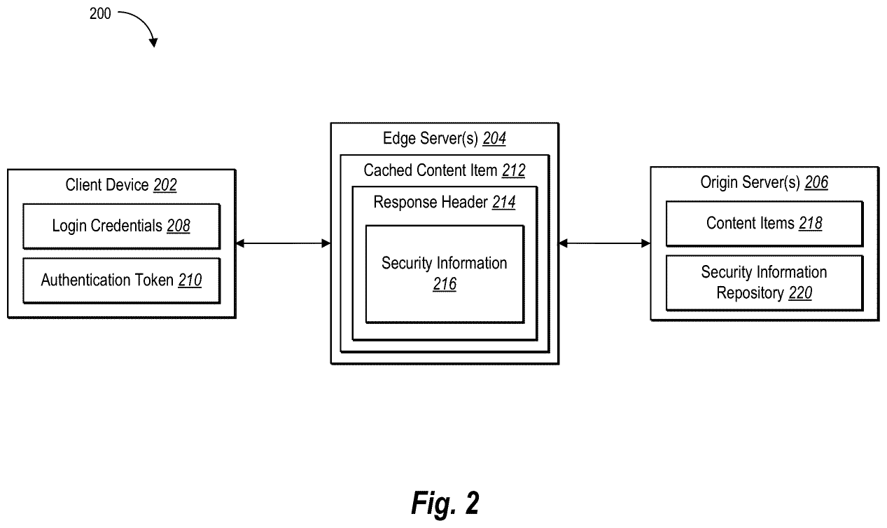

As previously mentioned, in one or more embodiments, the deferred authentication system 106 implements edge deferred authentication of requests for access to resources at one or more edge servers of a content delivery network. For instance, FIG. 2 illustrates the deferred authentication system 106 utilizing one or more edge servers 204 and one or more origin servers 206 of a content delivery network 200 in accordance with one or more embodiments. Specifically, FIG. 2 illustrates an exemplary configuration (i.e., architecture) of a content delivery network 200, wherein a client device 202 is in communication with the one or more edge servers 204 of the content delivery network 200. As also shown, the one or more edge servers 204 are in communication with one or more origin server(s) 206 of the content delivery network 200. For example, in one or more embodiments, the one or more edge servers 204 are located in close proximity to the client device 202, relative to the origin server 206.

As illustrated in FIG. 2, the client device 202 provides login credentials 208 to access a tenant account associated with the content delivery network 200. For example, login credentials 208 include but are not limited to an account name, username, passwords, and/or credentials for two-factor authentication. Also, the client device 202 has an authentication token 210 issued by the deferred authentication system 106 via the content delivery network 200 or by a third-party identity provider (IDP). Accordingly, the client device 202 is configured to enable a user to transmit a request for a resource or content item to the one or more edge servers 204.

In response to a request for access to a resource or content item, the deferred authentication system 106 determines whether the requested resource or content item is cached at the one or more edge server(s) 204. For example, as shown in FIG. 2, the edge server(s) 204 have at least one cached content item 212 with a corresponding response header 214, the response header 214 containing security information 216 associated with the cached content item 212. In some implementations, the cached content item 212 is received from content items 218 stored at the origin server(s) 206 in response to a request from the client device 202. Alternatively, the cached content item 212 can be received from the origin server(s) 206 in response to an earlier request from the client device 202, from an additional client device, from the edge server(s) 204, or otherwise as initiated by the deferred authentication system 106 (e.g., per an instruction to cache a particular content item at the edge server(s) 204 in advance).

Moreover, in some embodiments, the edge server(s) 204 receives the security information 216 along with (e.g., attached to) the cached content item 212 from the origin server(s) 206. For instance, in some embodiments, the deferred authentication system 106 generates the response header 214, including the security information 216, utilizing a security information repository 220 on the origin server(s) 206 to determine the security information 216 associated with the cached content item 212. Accordingly, as shown in FIG. 2, the security information 216 is attached to the cached content item 212 within the response header 214.

By utilizing the response header 214 to cache the security information 216 associated with the cached content item 212 at the edge server(s) 204, the deferred authentication system 106 efficiently validates requests for access to resources, such as a request received from the client device 202 to access the cached content item 212. For example, in some implementations, the deferred authentication system 106 receives subsequent requests from the client device 202 or additional client devices connected to the content delivery network 200. Furthermore, while conventional systems often implement a security dictionary at edge servers, in one or more embodiments the deferred authentication system 106 enables reduced operational overhead and use of storage space at edge servers 204 of the content delivery network 200.

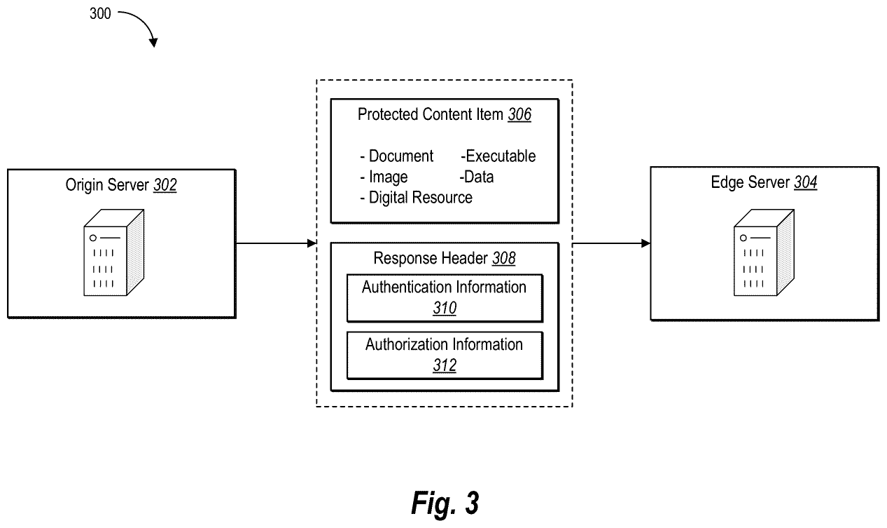

As previously mentioned, in one or more embodiments, the deferred authentication system 106 utilizes an origin server to provide content items with corresponding security information to edge servers of a content delivery network. For example, FIG. 3 illustrates an edge server 304 receiving a protected content item 306 with an attached response header 308 from an origin server 302. More specifically, FIG. 3 shows deferred authentication system 106 storing security information within the response header 308 when delivering the protected content item 306 from the origin server 302 to the edge server 304 of content delivery network 300.

For instance, in some embodiments, the edge server 304 receives the protected content item 306 from the origin server 302 and stores (i.e., caches) the protected content item 306 for subsequent requests from client devices. As illustrated, the protected content item 306 can comprise a resource including but not limited to a document, an image, an executable file or program, or other types of data or digital resources.

As further shown in FIG. 3, in some embodiments, the response header 308 associated with (and attached to) the protected content item includes authentication information 310 and authorization information 312. In some embodiments, for example, the authentication information 310 includes information that the deferred authentication system 106 utilizes to confirm one or more of: whether an authentication token provided by a client device is properly signed, whether the token is issued for the proper audience, whether the token is issued by a known and authorized issuer, or whether the token has not expired. In some embodiments, for example, the authentication information 310 of the response header 308 comprises one or more custom HTTP response headers, such as but not limited to inputs labels “x-auth-iss” followed by identification (i.e., a URL) of the issuer of the authentication token required for access to the protected content item 306, “x-auth-aud” followed by identification of the application(s) for which the requisite authentication token was issued, and/or “x-auth-jwk” followed by a public key used to verify the requisite authentication token. In one implementation, as a non-limiting example, the authentication information 310 of the response header 308 reads as follows:
x-auth-iss: http://login.domain.com/common/v2.0
x-auth-aud: 33ab5527-5331-434d-96f3-31e03f153853
x-auth-jwk: pkfklMDnNozPu24-nCrbvbBj00gith7VmxPm1px011dfwX0WEb . . .

Furthermore, in some embodiments, the authorization information 312 includes an indication of one or more of: whether the associated content item should be protected (i.e., subject to access control) or which tenants or users are authorized to access the associated content item. In some embodiments, for example, the authorization information 312 of the response header 308 comprises one or more custom HTTP response headers, such as but not limited to an input labeled “x-auth-allow” followed by a comma-separated list of users (e.g., user IDs) that are authorized to access the protected content item 306. In one or more implementations, as a non-limiting example, the authorization information 312 of the response header 308 reads as follows:
x-auth-allow-users: *@domain.com, john@example.com

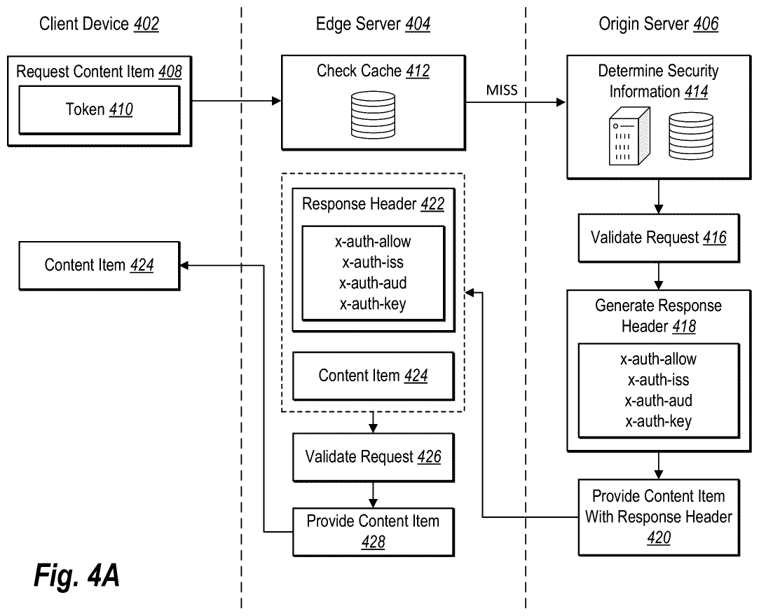

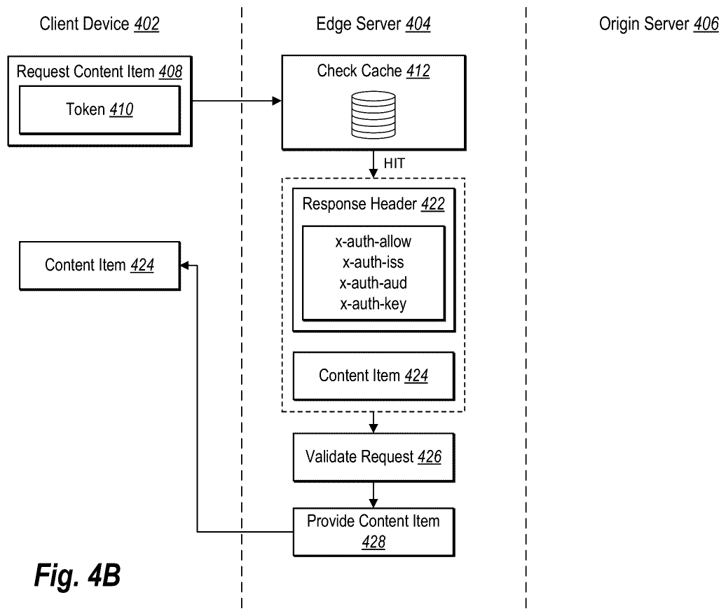

As previously mentioned, the deferred authentication system 106 utilizes edge deferred authentication within a content delivery network to validate requests for access to resources or content items. For example, FIGS. 4A-4B illustrate process flowcharts of two example implementations of the deferred authentication system 106 responding to a request to access received from a client device 402 at an edge server 404 of a content delivery network.

Specifically, FIG. 4A illustrates an example implementation wherein the deferred authentication system 106 determines at 412, in response to receiving the request at 408, that the requested content item 424 is not cached or otherwise available at the edge server 404. As shown, in response to determining that the requested content item 424 is not available at the edge server 404, the deferred authentication system 106 issues a request to an origin server 406 for the content item 424. In response, the deferred authentication system 106, at the origin server 406, performs an act 414 of determining security information for the requested content item 424 (e.g., utilizing a security information repository as described above in relation to FIGS. 1-3). As shown in FIG. 4A, in some embodiments, the deferred authentication system 106 validates the request at 416, utilizing the security information determined at the act 414 (e.g., by authenticating a token 410 provided with the request by the client device), to ensure that the request received from the edge server 404 is authentic and authorized prior to generating and delivering the security information to be cached at the edge server 404.

As illustrated, the deferred authentication system 106 utilizes security information stored at the origin server 406 to generate a response header at an act 418, the response header containing security information for the requested content item 424 (e.g., authentication and/or authorization information as described above in relation to FIG. 3). In response, the deferred authentication system 106 provides, at an act 420, the content item 424 with the response header 422 to the edge server 404 via the origin server 406 to be cached on the edge server 404. With the response header 422 and the content item 424 cached at the edge server 404, the deferred authentication system 106 validates the request for access at an act 426, utilizing the security information from the response header 422 attached to the cached content item 424. Upon validation of the request, the deferred authentication system 106 provides (or otherwise grants access to), at an act 428, the requested content item 424 to the client device 402 via the edge server 404.

Relatedly, FIG. 4B illustrates an example implementation wherein the deferred authentication system 106 determines at the act 412, in response to receiving the request at the act 408, that the requested content item 424 is cached at the edge server 404 with the corresponding response header 422 having the security information associated with the requested content item 424. For example, FIG. 4B can comprise a subsequent request for the content item 424 from a different client device. As shown, with the content item 424 already cached at the edge server 404 with security information in the corresponding response header 422, the deferred authentication system 106 can implement edge deferred authentication (i.e., without requesting data from the origin server 406).

Accordingly, in response to determining, at the act 412, that the requested content item 424 is cached at the edge server 404, the deferred authentication system 106 validates the request at the act 426 utilizing security information from the response header 422 attached to the cached content item 424 (e.g., by authenticating the token 410 provided by the client device 402 with the request for access). Upon validation of the request, the deferred authentication system 106 provides (or otherwise grants access to), at the act 428, the requested content item 424 to the client device 402 via the edge server 404.

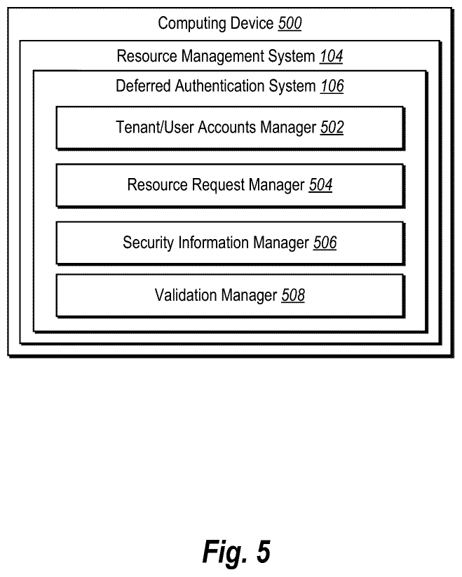

Turning now to FIG. 5, additional detail will be provided regarding components and capabilities of one or more embodiments of the deferred authentication system 106. In particular, FIG. 5 illustrates an example deferred authentication system 106 executed by a computing device 500 (e.g., the server devices(s) 102 including origin servers or edges servers or the third-party system(s) 116). As shown by the embodiment of FIG. 5, the computing device 500 includes or hosts the resource management system 104 and the deferred authentication system 106. Furthermore, as shown in FIG. 5, the deferred authentication system 106 includes a tenant/user accounts manager 502, a resource request manager 504, a security information manager 506, and a validation manager 508.

As just mentioned, and as illustrated in the embodiment of FIG. 5, the deferred authentication system 106 includes the tenant/user accounts manager 502. For instance, the tenant/user accounts manager 502 identifies and/or administers tenant/user accounts. For example, in some embodiments, the tenant/user accounts manager 502 identifies, stores, and maintains account information, such as but not limited to account histories, login credentials, authentications tokens, and authorization data associated with tenant/user accounts (e.g., as described above in relation to FIG. 2).

Furthermore, as shown in FIG. 5, the deferred authentication system 106 includes the resource request manager 504. For instance, the resource request manager 504 receives (or identifies), from tenant client devices, requests to access resources and content items. Also, in one or more embodiments, the resource request manager 504 forwards requests received at an edge server to an origin server when the deferred authentication system 106 determines that the requested resource or content item is not cached within the edge server (e.g., as described above in relation to FIG. 4B).

In addition, as shown in FIG. 5, the deferred authentication system 106 includes the security information manager 506. For instance, the security information manager 506 identifies, stores, maintains, and/or administrates security information for the resources of the resource management system 104. In some embodiments, for example, the security information manager 506 stores and maintains security information within a security information repository of one or more edge servers (e.g., as described above in relation to FIGS. 1-2). Also, in some embodiments, the security information manager 506 generates a response header with security information for a requested resource (e.g., as described above in relation to FIGS. 3 and 4B).

As also shown in FIG. 5, the deferred authentication system 106 includes the validation manager 508. For instance, the validation manager 508 identifies authentication and/or authorization information included in a request for access to a protected resource and compares such information to security information associated with the requested resource (e.g., as described above in relation to FIGS. 4A-4B). In some embodiments, the validation manager 508 compares, at an origin server, received authorization and/or authentication information with security information stored in a security information repository prior to the deferred authentication system 106 generating a response header to cache at one or more edge servers (e.g., as described above in relation to FIG. 4B).

Although not illustrated, in some implementations the deferred authentication system 106 (and the computing device 500) includes a storage manager. For example, a storage manager can include one or more memory devices that store or cache information for the deferred authentication system 106. To illustrate, the storage manager can include security information, cached resources, response headers, and/or requests/responses.

Each of the components 502-508 of the deferred authentication system 106 can include software, hardware, or both. For example, the components 502-508 can include one or more instructions stored on a computer-readable storage medium and executable by processors of one or more computing devices, such as a client device or server device. When executed by the one or more processors, the computer-executable instructions of the deferred authentication system 106 can cause the computing device(s) 500 to perform the methods described herein. Alternatively, the components 502-508 can include hardware, such as a special-purpose processing device to perform a certain function or group of functions. Alternatively, the components 502-508 of the deferred authentication system 106 can include a combination of computer-executable instructions and hardware.

Furthermore, the components 502-508 of the deferred authentication system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 502-508 may be implemented as a stand-alone application, such as a desktop or mobile application. Furthermore, the components 502-508 may be implemented as one or more web-based applications hosted on a remote server. The components 502-508 may also be implemented in a suite of mobile device applications or “apps.” To illustrate, the components 502-508 may be implemented in an application, including but not limited to, ADOBE PHOTOSHOP, ADOBE PREMIERE, ADOBE LIGHTROOM, ADOBE ILLUSTRATOR, ADOBE SUBSTANCE, ADOBE CREATIVE CLOUD, or ADOBE SENSEI. The foregoing are either registered trademarks or trademarks of Adobe Systems Incorporated in the United States and/or other countries.

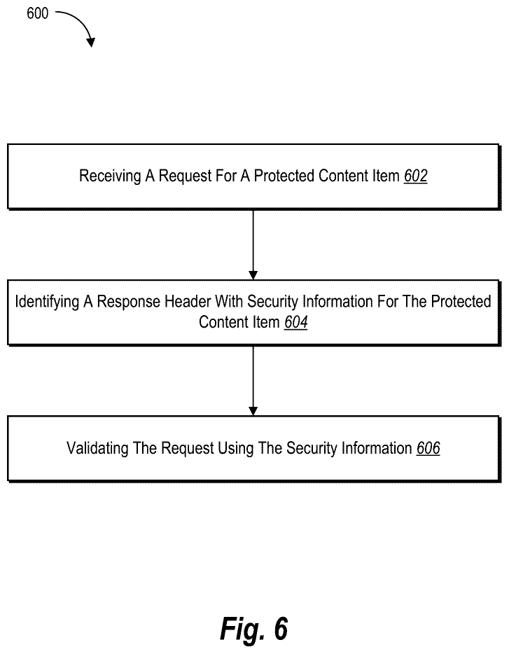

FIGS. 1-5, the corresponding text, and the examples provide a number of different methods, systems, devices, and non-transitory computer-readable media of the deferred authentication system 106. In addition to the foregoing, one or more embodiments can also be described in terms of flowcharts comprising acts for accomplishing a particular result, as shown in FIG. 6. The acts shown in FIG. 6 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 6. In some embodiments, a system can be configured to perform the acts of FIG. 6. Alternatively, the acts of FIG. 6 can be performed as part of a computer-implemented method.

As mentioned above, FIG. 6 illustrates a flowchart of a series of acts 600 for implementing edge deferred authentication of resource access requests in accordance with one or more embodiments. While FIG. 6 illustrates acts according to one embodiment, alternative embodiments may omit, add to, reorder, and/or modify any acts shown in FIG. 6.

As shown in FIG. 6, the series of acts 600 includes an act 602 of receiving a request for a protected content item. In particular, in one or more embodiments, the act 602 includes receiving, at one or more edge servers from a client device, a request to access a protected content item. In some embodiments, the act 602 includes receiving, from an earlier client device, an earlier request to access the protected content item. In some embodiments, the act 602 includes receiving, from a client device, a request to access a protected content item of one or more content items stored on one or more memory devices.

As shown in FIG. 6, the series of acts 600 includes an act 604 for identifying a response header with security information for the protected content item. For example, in one or more embodiments, the act 604 includes determining, in response to receiving the request to access the protected content item, that the protected content item is stored at the one or more edge servers with a corresponding response header received from an origin server. In some embodiments, the act 604 includes, in response to determining that the protected content item is not stored on one or more edge servers, generating a request, to an origin server, for the protected content item and receiving, from the origin server, the protected content item with a response header comprising security information from a security information repository of the origin server.

In one or more embodiments, the act 604 includes, in response to determining that security information for the protected content item is not available at an edge server, generating a request, to an origin server, for the security information and receiving, from the origin server, the security information in a response header for the protected content item. In some embodiments, determining that the security information for the protected content item is not available at the edge server comprises determining that the protected content item has an invalid response header comprising expired security information.

Furthermore, in some embodiments, the act 604 includes identifying, from the request, an authentication token for a user account of a multi-tenant content delivery network. In some embodiments, the act 604 includes extracting, at the one or more edge servers, authentication information from the response header, wherein the authentication information comprises an issuer claim, an audience claim, or a public key for validating authentication tokens. In some embodiments, the act 604 includes extracting authorization information from the response header, wherein the authorization information comprises a list of authorized accounts.

Moreover, in some embodiments, the act 604 includes, in response to receiving the earlier request, determining that the protected content item is not stored on the one or more edge servers and requesting, from the origin server, the protected content item. Also, in some embodiments, the act 604 includes, in response to requesting the protected content item, receiving, from the origin server, the protected content item with the response header, wherein the response header comprises one or more Hypertext Transfer Protocol (HTTP) response headers. In one or more embodiments, the act 604 also includes caching the protected content item with the one or more HTTP response headers at the one or more edge servers for validating subsequent requests for the protected content item. Further, in some embodiments, the act 604 includes, in response to receiving the request to access the protected content item, generating, at the origin server, the response header utilizing a security information repository at the origin server and transmitting the response header from the origin server to the one or more edge servers. In one or more embodiments, the act 604 further includes, in response to receiving an additional request from an additional client device, determining that the protected content item with the response header is stored at the one or more edge servers.

As shown in FIG. 6, the series of acts 600 include an act 606 of validating the request using the security information. In some embodiments, for instance, act 606 includes validating, at the one or more edge servers, the request to access the protected content item utilizing security information from the response header. Furthermore, in some embodiments, the act 606 includes validating the request at the edge server utilizing the authentication token and the response header. In some embodiments, the act 606 includes validating the request to access the protected content item utilizing the security information from the response header and, in response to receiving an additional request from an additional client device for the protected content item, validating the additional client device utilizing the security information from the response header. Also, in one or more embodiments, the act 606 includes extracting an authentication token for a user account of a multi-tenant content delivery network from the request and validating the request by comparing the authentication token and the security information from the response header.

Furthermore, in some embodiments, the act 606 includes authenticating the client device at the one or more edge servers utilizing the authentication information. In some embodiments, the act 606 includes authorizing, at the one or more edge servers, the client device to access the protected content item based on the authorization information. Moreover, in one or more embodiments, the act 606 includes, prior to generating and transmitting the response header, validating the request at the origin server utilizing the security information repository. In one or more embodiments, the act 606 includes determining the security information from the response header by extracting authentication information and authorization information from the response header and providing the protected content item to the client device based on the authentication and authorization information extracted from the response header.

Moreover, in some embodiments, validating the request to access the protected content item comprises extracting, at the edge server, authentication information from the response header, wherein the authentication information comprises an issuer claim, an audience claim, or a public key for validating authentication tokens and authenticating the client device at the edge server utilizing the authentication information. Additionally or alternatively, in some embodiments, validating the request to access the protected content item comprises extracting, at the edge server, authorization information from the response header, wherein the authorization information comprises a list of authorized accounts and authorizing, at the edge server, the client device to access the protected content item based on the authorization information.

In one or more embodiments, the act 606 further includes, in response to receiving an additional request from an additional client device and determining that the protected content item with the response header is stored at the one or more edge servers, extracting the security information from the response header stored at the one or more edge servers and validating the additional client device utilizing the security information extracted from the response header stored at the one or more edge servers.

In addition to the acts described above, the deferred authentication system 106 can also perform an act of providing the protected content item to a client device. In some embodiments, the act for providing the protected content item to a client device comprises, in response to validating the request, providing the content item to the client device via the edge server. Furthermore, some embodiments include an act for delivering, in response to validating the request to access the protected content item, the protected content item from the one or more edge servers to the client device. Moreover, some embodiments include an act for providing the protected content item from the one or more edge servers to the earlier client device. Also, one or more embodiments include an act for, in response to validating the request utilizing the security information from the response header, providing the protected content item to the client device.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 7 illustrates a block diagram of an example computing device 700 that may be configured to perform one or more of the processes described above. One will appreciate that one or more computing devices, such as the computing device 700 may represent the computing devices described above (e.g., server device(s) 102, tenant client devices 110a-c, client device 202, client device 402, and computing device(s) 500). In one or more embodiments, the computing device 700 may be a mobile device (e.g., a mobile telephone, a smartphone, a PDA, a tablet, a laptop, a camera, a tracker, a watch, a wearable device, etc.). In some embodiments, the computing device 700 may be a non-mobile device (e.g., a desktop computer or another type of client device). Further, the computing device 700 may be a server device that includes cloud-based processing and storage capabilities.

As shown in FIG. 7, the computing device 700 can include one or more processor(s) 702, memory 704, a storage device 706, input/output interfaces 708 (or “I/O interfaces 708”), and a communication interface 710, which may be communicatively coupled by way of a communication infrastructure (e.g., bus 712). While the computing device 700 is shown in FIG. 7, the components illustrated in FIG. 7 are not intended to be limiting. Additional or alternative components may be used in other embodiments. Furthermore, in certain embodiments, the computing device 700 includes fewer components than those shown in FIG. 7. Components of the computing device 700 shown in FIG. 7 will now be described in additional detail.

In particular embodiments, the processor(s) 702 includes hardware for executing instructions, such as those making up a computer program. As an example, and not by way of limitation, to execute instructions, the processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, the storage device 706 can include a non-transitory storage medium described above. The storage device 706 may include a hard disk drive (HDD), flash memory, a Universal Serial Bus (USB) drive or a combination these or other storage devices.

As shown, the computing device 700 includes one or more 110 interfaces 708, which are provided to allow a user to provide input to (such as user strokes), receive output from, and otherwise transfer data to and from the computing device 700. These 110 interfaces 708 may include a mouse, keypad or a keyboard, a touch screen, camera, optical scanner, network interface, modem, other known 110 devices or a combination of such 110 interfaces 708. The touch screen may be activated with a stylus or a finger.

The 110 interfaces 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, 110 interfaces 708 are configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 provides one or more interfaces for communication (such as, for example, packet-based communication) between the computing device and one or more other computing devices or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can include hardware, software, or both that connects components of computing device 700 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. A non-transitory computer readable medium storing executable instructions which, when executed by a processing device, cause the processing device to perform operations comprising:
receiving, at an edge server from a client device, a request to access a protected content item;
in response to receiving the request, determining that the protected content item is stored at the edge server with a corresponding response header comprising security information for the protected content item, wherein the security information was received from an origin server and stored at the edge server with the protected content item prior to receiving the request to access the protected content item;
validating, at the edge server, the request utilizing the security information stored within the corresponding response header of the protected content item at the edge server; and
in response to validating the request, delivering the protected content item from the edge server to the client device.

2. The non-transitory computer readable medium of claim 1, wherein the operations further comprise:
identifying, from the request, an authentication token for a user account of a multi-tenant content delivery network; and
validating the request at the edge server utilizing the authentication token and the corresponding response header of the protected content item.

3. The non-transitory computer readable medium of claim 1, wherein the operations further comprise:
receiving, from an earlier client device, an earlier request to access the protected content item;
in response to receiving the earlier request, determining that the protected content item is not stored on the edge server; and
requesting, from the origin server, the protected content item.

4. The non-transitory computer readable medium of claim 3, wherein the operations further comprise:
in response to requesting the protected content item, receiving, from the origin server, the protected content item with the corresponding response header, wherein the corresponding response header comprises one or more Hypertext Transfer Protocol (HTTP) response headers.

5. The non-transitory computer readable medium of claim 4, wherein the operations further comprise:
providing the protected content item from the edge server to the earlier client device; and
caching the protected content item with the one or more HTTP response headers at the edge server for validating subsequent requests for the protected content item.

6. The non-transitory computer readable medium of claim 1, wherein the operations further comprise:
extracting, at the edge server, authentication information from the corresponding response header of the protected content item, wherein the authentication information comprises an issuer claim, an audience claim, or a public key for validating authentication tokens; and
authenticating the client device at the edge server utilizing the authentication information.

7. The non-transitory computer readable medium of claim 1, wherein the operations further comprise:
extracting authorization information from the corresponding response header of the protected content item, wherein the authorization information comprises a list of authorized accounts; and
authorizing, at the edge server, the client device to access the protected content item based on the authorization information.

8. The non-transitory computer readable medium of claim 1, wherein the operations further comprise:
in response to receiving the request to access the protected content item, generating, at the origin server, the corresponding response header for the protected content item utilizing a security information repository at the origin server; and
transmitting the corresponding response header for the protected content item from the origin server to the edge server.

9. The non-transitory computer readable medium of claim 8, wherein the operations further comprise:
prior to generating and transmitting the corresponding response header for the protected content item, validating the request at the origin server utilizing the security information repository.

10. A system comprising:
one or more memory devices comprising one or more content items; and
one or more edge servers configured to cause the system to:
receive, from a client device, a request to access a protected content item of the one or more content items;
in response to determining that the protected content item is not stored on the one or more edge servers, generate a request, to an origin server, for the protected content item;
receive, from the origin server, the protected content item with a response header comprising security information from a security information repository of the origin server;
store, at the one or more edge servers, the protected content item with the response header comprising the security information;
validate the request to access the protected content item utilizing the security information from the response header; and
in response to receiving an additional request from an additional client device for the protected content item, validate the additional client device utilizing the security information from the response header stored with the protected content item at the one or more edge servers.

11. The system of claim 10, wherein the one or more edge servers are further configured to cause the system to:
extract an authentication token for a user account of a multi-tenant content delivery network from the request; and
validate the request by comparing the authentication token and the security information from the response header.

12. The system of claim 10, wherein the one or more edge servers are further configured to cause the system to, in response to validating the request utilizing the security information from the response header, provide the protected content item to the client device.

13. The system of claim 10, wherein the one or more edge servers are further configured to cause the system to:
determine the security information from the response header by extracting authentication information and authorization information from the response header; and
provide the protected content item to the client device based on the authentication information and the authorization information extracted from the response header.

14. The system of claim 10, wherein the one or more edge servers are further configured to cause the system to, in response to receiving the additional request from the additional client device:
determine that the protected content item with the response header is stored at the one or more edge servers;
extract the security information from the response header stored at the one or more edge servers; and
validate the additional client device utilizing the security information extracted from the response header stored at the one or more edge servers.

15. A computer-implemented method comprising:
receiving, at an edge server from a client device, a request to access a protected content item;
in response to determining that security information for the protected content item is not available at the edge server, generating a request, to an origin server, for the security information;
receiving, from the origin server, the security information in a response header for the protected content item;
storing, with the protected content item at the edge server, the response header with the security information; and
validating the request, at the edge server, utilizing the security information in the response header stored with the protected content item at the edge server.

16. The computer-implemented method of claim 15, wherein determining that the security information for the protected content item is not available at the edge server comprises determining that the protected content item has an invalid response header comprising expired security information.

17. The computer-implemented method of claim 15, wherein validating the request to access the protected content item comprises:
extracting, at the edge server, authentication information from the response header, wherein the authentication information comprises an issuer claim, an audience claim, or a public key for validating authentication tokens; and
authenticating the client device at the edge server utilizing the authentication information.

18. The computer-implemented method of claim 15, wherein validating the request to access the protected content item comprises:
extracting, at the edge server, authorization information from the response header, wherein the authorization information comprises a list of authorized accounts; and
authorizing, at the edge server, the client device to access the protected content item based on the authorization information.

19. The computer-implemented method of claim 15, further comprising, in response to validating the request, providing the protected content item to the client device via the edge server.

20. The computer-implemented method of claim 15, further comprising:
receiving an additional request to access the protected content item;
determining that the response header for the protected content item on the edge server contains the security information; and
validating the additional request at the edge server utilizing the security information from the response header.
